(19) United States
(12) Patent Application Publication
(10) Pub. No.: US 2013/0198739 A1
(43) Pub. Date: Aug. 1, 2013

(54) Validation of Business Continuity Preparedness of a Virtual Machine

(71) Applicants: Rahul Razdan, Hyderabad (IN); Arulseelan Thiruppathi, Hyderabad (IN); Phani Chiruvolu, Hyderabad (IN); Nishant Gupta, Dehli (IN); Amit Kumar Saxena, Mumbai (IN); Vinod Atal, Hyderabad (IN); Krishan Kumar Attre, Hyderabad (IN)

(72) Inventors: Rahul Razdan, Hyderabad (IN); Arulseelan Thiruppathi, Hyderabad (IN); Phani Chiruvolu, Hyderabad (IN); Nishant Gupta, Dehli (IN); Amit Kumar Saxena, Mumbai (IN); Vinod Atal, Hyderabad (IN); Krishan Kumar Attre, Hyderabad (IN)

(73) Assignee: Microsoft Corporation, Redmond, WA (US)

(21) Appl. No.: 13/360,973

(22) Filed: Jan. 30, 2012

(51) Int. Cl. G06F 9/455

(52) U.S. Cl. 718/1

(57) ABSTRACT

Techniques for validating business continuity preparedness of a virtual machine are described herein. The techniques may include executing a workload on a virtual machine and replicating the workload to another virtual machine. The replication may include generating one or more logs indicating changes that have occurred on the virtual machine and sending the one or more logs to the other virtual machine. Upon initiation of a failover, the workload may stop execution on the virtual machine and a log may be sent to the other virtual machine. The log may indicate changes occurring on the virtual machine to a point in time when execution of the workload stopped. The log may be stored to the other virtual machine. The workload may continue execution on the other virtual machine and may be replicated to the virtual machine.

### BACKGROUND

Workloads running on virtual machines are often replicated to ensure business continuity of an organization utilizing the virtual machines. To initiate replication, changes that have occurred during execution of a workload on a primary virtual machine are transferred from the primary virtual machine to a replica virtual machine. These changes are applied (e.g., stored) to the replica virtual machine to synch the replica virtual machine to the primary virtual machine. After the initial set up, further changes occurring on the primary virtual machine are transferred to the replica virtual machine at regular intervals.

When an event (e.g., disaster) occurs causing the primary virtual machine to shut down, the workload may fail over from the primary virtual machine to the replica virtual machine and continue execution on the replica virtual machine.

### SUMMARY

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

This disclosure is related to, in part, generating a log at a first virtual machine indicating changes that have occurred during execution of a workload on the first virtual machine. The workload may stop execution on the first virtual machine and the log may then be sent to a second virtual machine. The log may indicate changes occurring on the first virtual machine to a point in time when execution of the workload stopped on the first virtual machine.

Thereafter, the workload may continue execution on the second virtual machine. A further log may be generated at the second virtual machine indicating changes that have occurred during execution of the workload on the second virtual machine. The workload may stop execution on the second virtual machine and the further log may be sent to the first virtual machine. The workload may then continue execution on the first virtual machine.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which techniques described herein may be implemented.

FIGS. 2A-2F illustrate an example process of generating one or more logs, transferring the one or more logs between a primary virtual machine(s) and a replica virtual machine(s), and applying the one or more logs to the primary virtual machine(s) and the replica virtual machine(s).

FIG. 3 illustrates an example user interface that may be presented for validating a level of business continuity preparedness of a virtual machine.

FIGS. 4A-4B illustrate an example process of replicating a workload from a primary virtual machine(s) to a replica virtual machine(s), failing over the workload from the primary virtual machine(s) to the replica virtual machine(s), and validating execution of the workload on the replica virtual machine(s).

FIGS. 5A-5B illustrate example processes of transferring a log between virtual machines when one of the virtual machines has migrated to be implemented on a particular computing device.

### DETAILED DESCRIPTION

In the replication systems discussed above, an entity (e.g., an application, organization, user, etc.) may wish to validate that a workload will properly failover from a primary virtual machine to a replica virtual machine. That is, the entity may wish to validate that the workload will switch execution over from the primary virtual machine to the replica virtual machine with minimal or no loss of data (e.g., data generated and/or modified in execution of the workload) upon the occurrence of a disaster or other specified event.

To perform this validation, a workload is often failed over to a replica virtual machine, executed on the replica virtual machine, and failed back to a primary virtual machine. However, these existing validation techniques are complex to implement and often result in a loss of data.

For example, in existing techniques data is often lost when a workload is failed over to a replica virtual machine. The data loss often occurs because the workload is not replicated by the replica virtual machine. In addition, in existing techniques the workload is often executed simultaneously on a primary virtual machine and a replica virtual machine after the failover. This often causes corruption of and/or inconsistencies in data, known as the “split-brain” problem.

Furthermore, existing validation techniques do not allow an individual to specify when to start a workload on a replica virtual machine. In addition, existing techniques for failing back from a replica virtual machine to a primary virtual machine are complex and substantially different from failing over to the replica virtual machine. Moreover, existing validation techniques do not allow a virtual machine to migrate from one computing device to another computing device while a workload is failing over to a replica virtual machine and/or failing back to a primary virtual machine.

This disclosure describes techniques for validating business continuity preparedness of a virtual machine without data loss. For example, this disclosure describes techniques for replicating a workload, failing over a workload from a first virtual machine (e.g., a primary virtual machine) to a second virtual machine (e.g., a replica virtual machine), and failing back the workload from the second virtual machine to the first virtual machine without data loss.

In particular aspects, this disclosure is directed to executing a workload on a first virtual machine (e.g., a primary virtual machine). During execution, a log may be generated indicating changes that have occurred on the first virtual machine during execution of the workload. Upon initiation of a failover, the workload may stop execution on the first virtual machine. The log may be sent to a second virtual machine (e.g., a replica virtual machine) indicating changes occurring on the first virtual machine to a point in time when execution of the workload was stopped. The log may be applied (e.g., stored) to memory of the second virtual machine to bring the first and second virtual machines in synch.

Thereafter, the workload may continue execution on the second virtual machine. During execution, a log may be generated indicating changes that have occurred on the second virtual machine. Upon initiation of a failback, the workload may stop execution on the second virtual machine. The log generated at the second virtual machine may be sent to the first virtual machine indicating changes occurring on the second virtual machine to a point in time when execution of the workload stopped on the second virtual machine. The log may be applied (e.g., stored) to memory of the first virtual machine to bring the first and second virtual machines in synch. Thereafter, the workload may continue execution on the first virtual machine.

By implementing these techniques, business continuity preparedness of a virtual machine may be validated without loss of data. That is, an entity may validate that a workload will failover from a virtual machine to another virtual machine without loss of data. For instance, by stopping execution of a workload on a first virtual machine and sending a log to a second virtual machine indicating changes up to a point in time when execution of the workload was stopped, the first and second virtual machines may be synched to include the same changes up to that particular point in time. This may ensure that when the workload continues execution on the second virtual machine, the second virtual machine is aware of changes up to the point in time when execution stopped on the first virtual machine.

In addition, by stopping execution of the workload on the first virtual machine, data corruption and/or inconsistencies associated with the above-noted “split-brain” problem may be avoided. Furthermore, by generating a log at the second virtual machine during execution of the workload at the second virtual machine and sending the log to the first virtual machine, the workload may be protected from data loss throughout the validation process.

Moreover, in some instances, the validation techniques of this disclosure provide simplified techniques to validate business continuity preparedness of a virtual machine. That is, by utilizing similar techniques for failing over to a particular virtual machine and failing back from the particular virtual machine, errors and/or loss of data associated with complex validation techniques may be avoided.

This brief introduction, including section titles and corresponding summaries, is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Illustrative Architecture

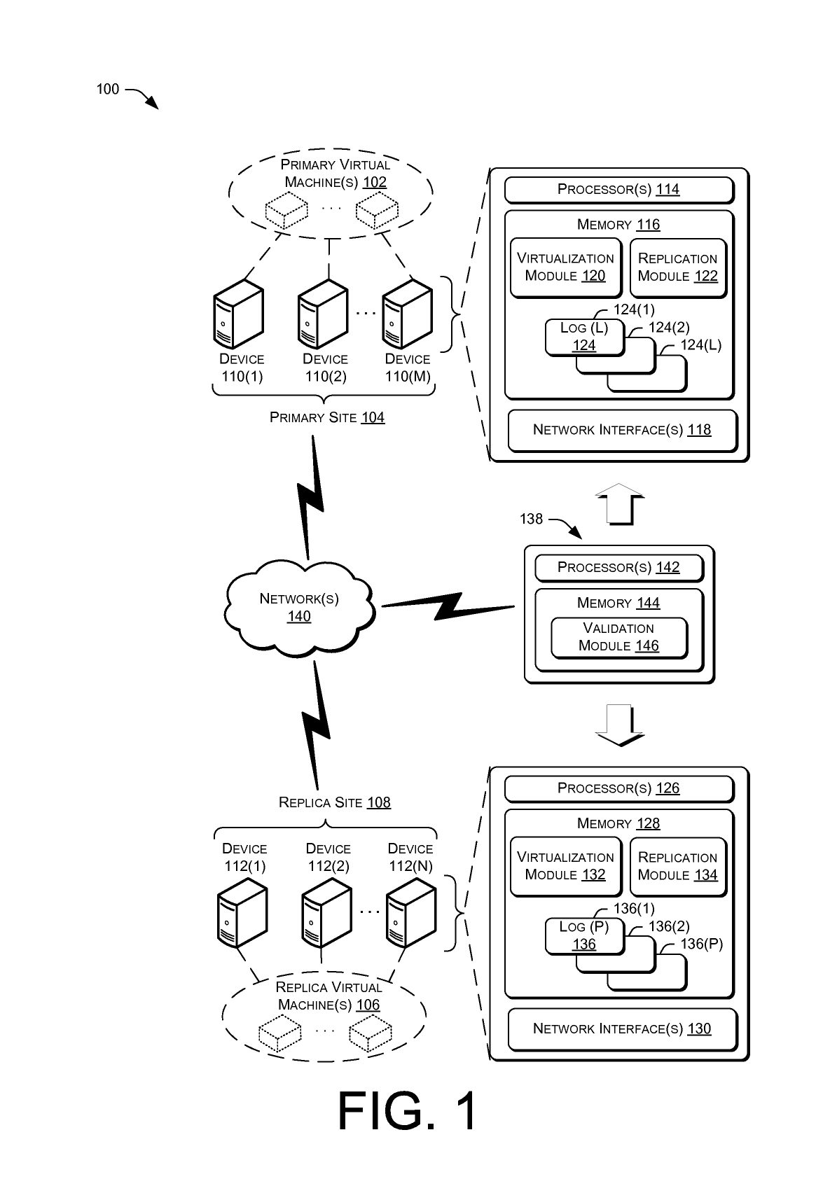

FIG. 1 illustrates an example architecture 100 in which techniques described herein may be implemented. The architecture 100 includes one or more primary virtual machines 102 implemented at a primary site 104 and configured to communicate with one or more replica virtual machines 106 implemented at a replica virtual site 108. The primary site 104 may be located at a geographical location that is different than a geographical location of the replica site 108, such as a different room, building, city, region, state, country, etc.

The primary site 104 includes one or more computing devices 110(1), 110(2), . . . 110(M) (collectively referred to as computing device 110) implementing the one or more primary virtual machines 102. Meanwhile, the replica site 108 includes one or more computing devices 112(1), 112(2), . . . 112(N) (collectively referred to as computing device 112) implementing the one or more replica virtual machines 106. Each of the computing devices 110 and 112 may be implemented as, for example, one or more servers, one or more personal computers, one or more laptop computers, or a combination thereof. In one example, the computing devices 110 and/or 112 are configured in a cluster, data center, cloud computing environment, or a combination thereof.

Although not illustrated, the computing devices 110 and/or 112 may include and/or be communicatively coupled to one or more routers, switches, hubs, bridges, repeaters, or other networking devices and/or hardware components utilized to perform virtualization and/or replication operations. Each of the computing devices 110 and 112 may be configured to form one or more networks, such as a Local Area Network (LAN), Home Area Network (HAN), Storage Area Network (SAN), Wide Area Network (WAN), etc.

The computing device 110 is equipped with one or more processors 114, memory 116, and one or more network interfaces 118. The memory 116 may be configured to store data and one or more software and/or firmware modules, which are executable on the one or more processors 114 to implement various functions. In particular, the memory 116 may store a virtualization module 120 to perform virtualization operations for creating the one or more primary virtual machines 102 and/or executing a workload on the one or more primary virtual machines 102. These virtualization operations are well known by those of ordinary skill in the art.

The memory 116 may also store a replication module 122 to perform operations for replicating a workload. For example, the replication module 122 may generate and/or receive logs 124(1), 124(2), . . . 124(L). Each of the logs 124(1) to 124(L) may indicate and/or include changes that have occurred on the one or more primary virtual machines 102 and/or the one or more replica virtual machines 106 during execution of a workload. The replication module 122 may apply (e.g., store) one or more of the logs 124(1) to 124(L) to the memory 116 and/or send one or more of the logs 124(1) to 124(L) to the one or more replica virtual machines 106. As illustrated in FIG. 1, the logs 124(1) to 124(L) are stored in the memory 116.

A change may generally comprise one or more modifications, updates, alterations, and/or transfers of data associated with execution of a workload. For instance, as a particular workload is executed on one or more virtual machines, data may be modified, updated, altered, and/or transferred. Here, memory of one or more computing devices implementing the one or more virtual machines may be changed to reflect a change of the data.

To illustrate, if a workload associated with a bank is executing on one or more virtual machines, the workload may cause certain transactions to occur, such as a transfer of funds from one account to another account. In this illustration, the transfer of funds from one account to another is a change, where the transfer of funds causes data to be modified, updated, altered, and/or transferred.

Although the memory 116 is depicted in FIG. 1 as a single unit, the memory 116 (and all other memory described herein) may include one or a combination of computer readable media. Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The computing device 112 may include similar hardware and/or software components as the computing device 110. In the example of FIG. 1, the computing device 112 is equipped with one or more processors 126, memory 128, and one or more network interfaces 130. The memory 128 may be configured to store data and one or more software and/or firmware modules, which are executable on the one or more processors 126 to implement various functions. In particular, the memory 128 may store a virtualization module 132 to perform virtualization operations for creating the one or more replica virtual machines 106 and/or executing a workload on the one or more replica virtual machines 106.

The memory 128 may also store a replication module 134 to generate and/or receive logs 136(1), 136(2), . . . 136(P). Each of the logs 136(1) to 136(P) may indicate and/or include changes that have occurred on the one or more primary virtual machines 102 and/or the one or more replica virtual machines 106 during execution of a workload. Additionally, the replication module 134 may apply (e.g., store) one or more of the logs 136(1) to 136(P) to the memory 128 and/or send one or more of the logs 136(1) to 136(P) to the one or more primary virtual machines 102. As illustrated in FIG. 1, the logs 136(1) to 136(P) are stored in the memory 128.

The architecture 100 also includes a computing device 138 configured to communicate with the primary site 104 and/or replica site 108 via network(s) 140. The computing device 138 may be implemented as, for example, one or more servers, one or more personal computers, one or more laptop computers, one or more cell phones, one or more tablet devices, one or more personal digital assistants (PDA), or combinations thereof.

The computing device 138 includes one or more processors 142 and memory 144. The memory 144 may be configured to store data and one or more software and/or firmware modules, which are executable on the one or more processors 142 to implement various functions. In particular, the memory 144 may store a validation module 146 to perform operations for validating business continuity preparedness of one or more virtual machines.

For example, the validation module 146 may perform operations to failover and/or failback a workload, check configurations of one or more machines, and/or change one or more internet protocol (IP) addresses associated with one or more virtual machines. The validation module 146 may also perform other operations discussed in further detail below.

In addition, the validation module 146 may manage virtualization of one or more virtual machines, execution of a workload on one or more virtual machines, and/or replication of a workload. That is, the validation module 146 may send one or more instructions to hardware and/or software components to cause virtualization of one or more virtual machines, execution of a workload on one or more virtual machines, and/or replication of a workload.

Although the architecture 100 of FIG. 1 illustrates the validation module 146 as located within the computing device 138, in some examples the validation module 146 may be located in the computing device 110 and/or 112. Here, the computing device 138 may be eliminated entirely. In some examples, the validation module 146 is implemented as a virtual machine manager (e.g., a hypervisor) running on the computing device 110.

In addition, although modules (e.g., the modules 120, 122, 132, 134, and 146) are described herein as being software and/or firmware executable on a processor, in other embodiments, any or all of the modules may be implemented in whole or in part by hardware to execute the described functions.

As noted above, the computing device 110, computing device 112, and/or computing device 138 may communicate via the network(s) 140. The network(s) 140 may include any one or combination of multiple different types of networks, such as cellular networks, wireless networks, Local Area Networks (LANs), Wide Area Networks (WANs), and the Internet.

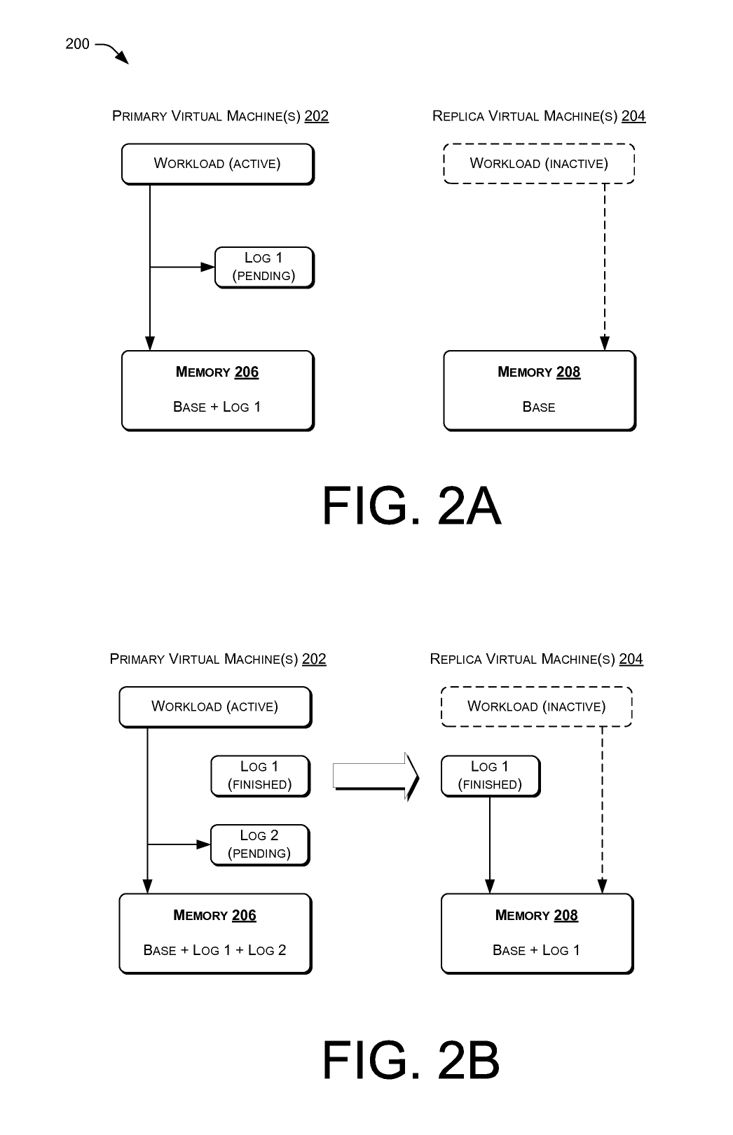

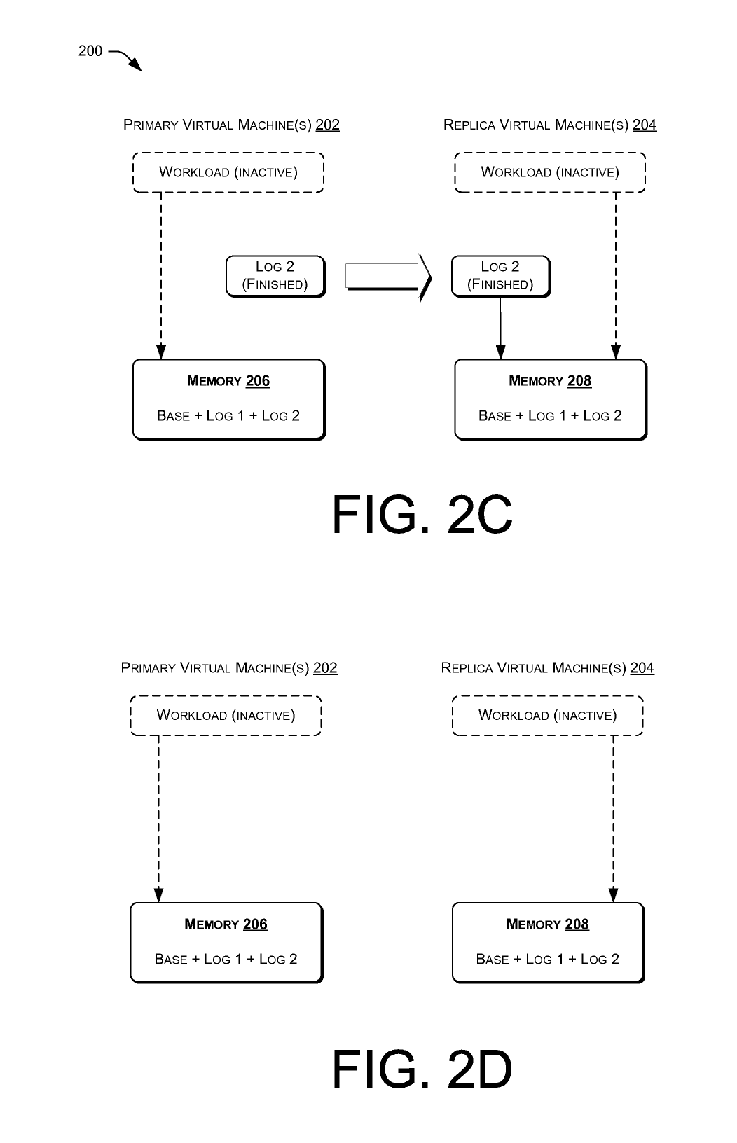

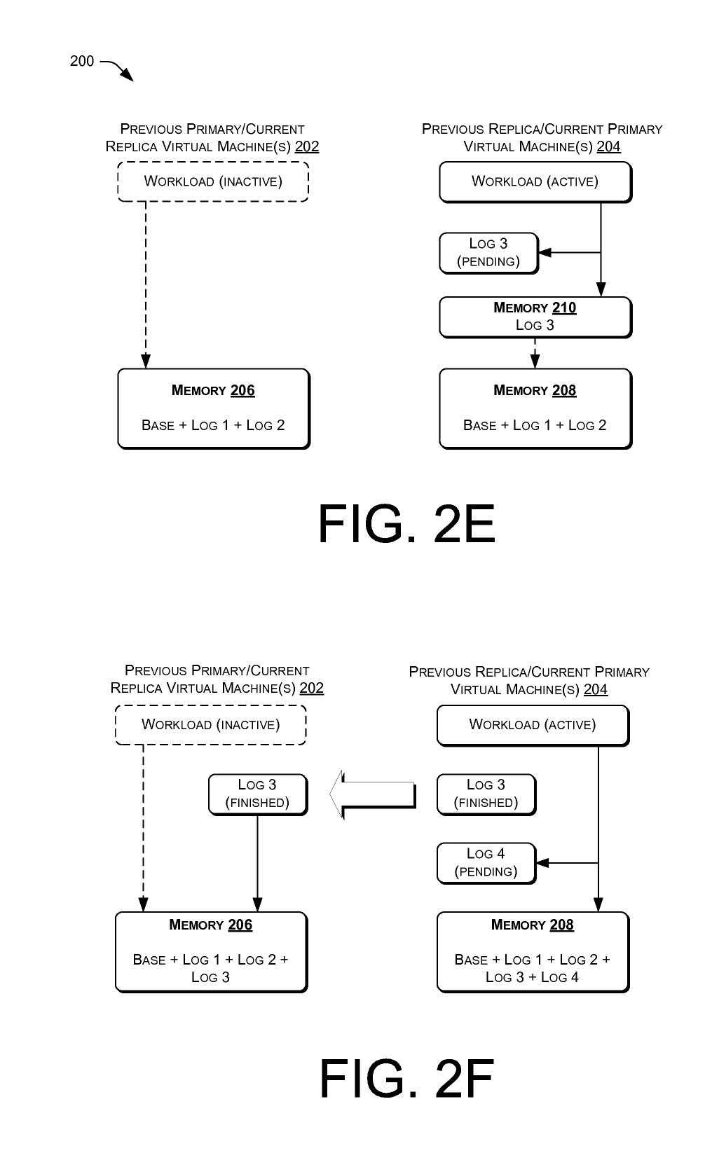

FIGS. 2A-2F illustrate an example process 200 of generating one or more logs, transferring the one or more logs between one or more primary virtual machines 202 and one or more replica virtual machines 204, and applying (e.g., storing) the one or more logs to the one or more primary virtual machines 202 and the one or more replica virtual machines 204. The one or more primary virtual machines 202 may collectively be referred to as primary virtual machine 202 and may be similar to the one or more primary virtual machines 102 of FIG. 1. Meanwhile, the one or more replica virtual machines 204 may collectively be referred to as replica virtual machine 204 and may be similar to the one or more replica virtual machines 106 of FIG. 1.

In FIG. 2A, the primary virtual machine 202 is configured to replicate a workload executing on the primary virtual machine 202 to the replica virtual machine 204. To initiate the replication, changes that have occurred to the primary virtual machine 202 up to a particular point in time are replicated (e.g., copied) to the replica virtual machine 204 by transferring base data to the replica virtual machine 204. The base data indicates and/or includes changes to the primary virtual machine 202 up to the particular point in time. The base data may include data stored in memory 206 of the primary virtual machine 202. Upon receipt of the base data, the replica virtual machine 204 may store the base data to memory 208 of the replica virtual machine 204.

After transferring the base data, additional changes caused by the workload may be replicated by generating and transferring logs. Each log may indicate and/or include changes to a virtual machine that have occurred during execution of the workload on the virtual machine. The log may comprise a log file, such as a server log. In some instances, logs are transferred at predetermined time intervals. Here, each log may indicate and/or include changes since a previous log transfer.

To illustrate, as the workload is actively executing on the primary virtual machine 202 in FIG. 2A, one or more changes occur to the primary virtual machine 202. During execution, the one or more changes may be stored to the memory 206 of the primary virtual machine 202. Additionally, the one or more changes may be stored to a log 1 to be transferred to the replica virtual machine 204. In some instances, the one or more changes are simultaneously stored to the memory 206 and the log 1.

At a particular time, the primary virtual machine 202 may transfer the log 1 to the replica virtual machine 204, as illustrated in FIG. 2B. The particular time may be based on a predetermined time interval, user input, and/or an instruction from a hardware and/or software component. While the log 1 is transferred, the primary virtual machine 202 may continue to store changes from the workload to the memory 206 and/or to a log 2. At the replica virtual machine 204, the log 1 may be stored to the memory 208.

This replication process of generating a log at the primary virtual machine 202 and transferring the log to the replica virtual machine 204 may continue for any period of time. This replication process may allow the workload to be replicated from the primary virtual machine 202 to the replica virtual machine 204.

With this replication established, a failover may be initiated at some time, causing the workload to switch execution from the primary virtual machine 202 to the replica virtual machine 204. In some instances, the failover is initiated in a planned manner without experiencing degradation in performance of the primary virtual machine 202. That is, the failover may be initiated without an event (e.g., disaster) occurring at the primary virtual machine 202 to cause performance to degrade. The failover may be initiated by a user and/or a module, such as the validation module 146 of FIG. 1.

The failover may be initiated by causing the primary virtual machine 202 to stop execution of the workload. In some instances, a check may be performed after the primary virtual machine 202 is initially instructed to stop execution. The check may verify that the workload has stopped execution. This may ensure that the workload does not execute simultaneously on the primary virtual machine 202 and the replica virtual machine 204. As illustrated in FIG. 2C, the workload has stopped execution on the primary virtual machine 202.

During initiation of the failover, configurations of a primary host machine may be checked to determine if the primary host machine is configured to receive one or more logs from the replica virtual machine 204. The primary host machine may comprise a computing device implementing the primary virtual machine 202. In the example architecture 100, a primary host machine may comprise one of the computing devices 110(1)-110(M). In some instances, the workload may be replicated back to the primary virtual machine 202 after the workload begins execution on the replica virtual machine 204. This check may verify that the primary host machine is configured for such replication.

Checking configurations of the primary host machine may include checking that the primary host machine is allowed to receive replication logs. In instances where the primary virtual machine 202 is implemented in cluster, this may include checking that a primary host broker of the primary virtual machine 202 is allowed to receive replication logs. Checking the configurations of the primary host machine may also include checking that the primary host machine supports an authentication mode utilized for replication. In some instances, the authentication mode includes Kerberos and/or certificate-based authentication.

Further, checking the configurations of the primary host machine may include checking that the primary host machine authorizes the replica machine 204 to send replication requests. In instances where the replica virtual machine 204 is implemented in cluster, this may include checking that the primary host machine authorizes a replica broker of the replica virtual machine 204 to send replication requests. As discussed in further detail below, a broker may comprise a module and may be implemented on a computing device which is previously indicated to a virtual machine.

After the workload stops execution on the primary virtual machine 202, the log 2 may be transferred from the primary virtual machine 202 to the replica virtual machine 204, as illustrated in FIG. 2C. The log 2 may include and/or indicate any remaining changes that have occurred up to the time when the workload stopped execution on the primary virtual machine 202.

The replica virtual machine 204 may store the log 2 to the memory 208. At this point, the primary virtual machine 202 and the replica virtual machine 204 are synched to include the same changes, as illustrated in FIG. 2D. By doing so, this may avoid data loss associated with failing over from the primary virtual machine 202 to the replica virtual machine 204 when changes remain on the primary virtual machine 202.

In FIG. 2E, the workload may failover from the primary virtual machine 202 to the replica virtual machine 204. That is, the workload may switch from the primary virtual machine 202 to the replica virtual machine 204 and continue execution on the replica virtual machine 204. The replica virtual machine 204 may continue execution at a location in the workload where the primary virtual machine 202 stopped execution. As discussed in further detail below, the workload is now executed on the replica virtual machine 204 and replicated back to the primary virtual machine 202. Here, the replica virtual machine 204 may act as a current primary virtual machine and the primary virtual machine 202 may act as a current replica virtual machine.

In some instances, the workload may continue execution on the replica virtual machine 204 after input is received from a user and/or an application, for example. In other instances, the workload may automatically continue execution as soon as the workload is switched over to the replica virtual machine 204. Here, a user may have previously specified to continue execution upon switching over to the replica virtual machine 204.

During execution of the workload, the replica virtual machine 204 may store changes to memory 210 and/or a log 3. The memory 208 may be different than the memory 208 allowing a snapshot of changes occurring up to the failover to be preserved separately. If, for example, errors occur on the replica virtual machine 204 during execution of the workload, then the correct data up to the failover will be preserved in the memory 208.

The memory 210 may be merged with the memory 208 after a predetermined time period has expired and/or a predetermined number of logs are generated and/or transferred. For example, the memory 210 may be merged when a predetermined time period expires since the log 3 was stored to the memory 210 and/or since the workload began execution on the replica virtual machine 204. Alternatively, or additionally, the memory 210 may be merged when a predetermined number of logs are generated at the replica virtual machine 204 and/or sent to the primary virtual machine 202. As illustrated in FIG. 2F, the memory 210 has merged the log 3 to the memory 208.

In some instances when multiple memory storage units are utilized during execution of a workload, a virtual machine experiences a particular performance level that is less than a performance level associated with utilizing one memory storage unit. Accordingly, by merging the memory 210 with the memory 208, the replica virtual machine 204 may avoid such performance degradation.

At a particular time, the replica virtual machine 204 may transfer the log 3 to the primary virtual machine 202, as illustrated in FIG. 2F. As similarly discussed above, the particular time may be based on a predetermined time interval, user input, and/or an instruction from a hardware and/or software component. While the log 3 is transferred, the replica virtual machine 204 may continue to store changes from the workload to the memory 208 and/or to a log 4. At the primary virtual machine 202, the log 3 may be stored to the memory 206.

By failing over the workload to the replica virtual machine 204, an entity (e.g., application, user, organization, etc.) may validate that the workload may switch execution to the replica virtual machine 204. Further, by replicating the workload back to the primary virtual machine 202 during execution of the workload on the replica virtual machine 204, the workload may remain protected throughout the validation process.

In some instances, the workload may failback to the primary virtual machine 202. Here, the failback may be initiated after the workload has executed on the replica virtual machine 204 for a predetermined time period. The failback process may be similar to the failover process discussed above with the replica virtual machine 204 now acting as a primary virtual machine and the primary virtual machine 202 now acting as a replica virtual machine. During failback, the replica virtual machine 204 may not need to transfer any substantial amounts of data, as the primary virtual machine 202 and the replica virtual machine 204 are substantially synched.

In some instances, the above validation techniques may allow an entity to validate business continuity preparedness of a virtual machine. That is, the above techniques may allow the entity to validate that a workload will failover from a virtual machine to another virtual machine without data loss. The organization may wish to validate business continuity to check preparedness for unforeseen disasters and/or comply with regulatory requirements associated with business continuity and/or disaster recovery.

### Illustrative IP Address Modification

In some implementations, an internet protocol (IP) address associated with a virtual machine may be changed after a workload fails over to another virtual machine and/or after the workload fails back. In some instances, this may allow a virtual machine running at a different site and associated with a different IP address scheme, to execute the workload properly after a failover and/or failback.

For example, a static IP address 1.1.1.1 may be configured on a primary virtual machine at a primary site. Here, when a workload is executing on the primary virtual machine, the virtual machine is running with an IP address 1.1.1.1. Thereafter, the workload may failover to a replica virtual machine at a replica site. In some instances, the IP address originally associated with the virtual machine (e.g., 1.1.1.1) may be changed to an IP address associated with the replica virtual machine (e.g., 2.2.2.2). That is, when the virtual machine begins execution of the workload at the replica site, the IP address of the virtual machine may be changed to 2.2.2.2. In some instances, this may allow a replica virtual machine running at a different site and associated with a different IP address scheme, to execute the workload properly.

Thereafter, if the workload is failed back to the primary virtual machine, the IP address associated with the virtual machine may be changed again. That is, the IP address of the virtual machine may be changed back to the original IP address 1.1.1.1.

### Illustrative Multi-Tier Application Support

In some implementations, an order may be specified to begin failover of and/or execution of modules associated with a workload. Here, the workload may comprise a multi-tier application having multiple modules. The multi-tier application may failover to and/or fail back from a virtual machine and/or begin execution in accordance with the specified order. The order may be specified by a user, the multi-tier application, another application, and so on.

To illustrate, a workload may comprise a first module (e.g., a presentation layer) executed on a first primary virtual machine, a second module (e.g., a middleware layer) executed on a second primary virtual machine, and a third module (e.g., a backend layer) executed on a third primary virtual machine. These three modules may collectively implement the workload as an application. During replication, the first module may be replicated to a first replica virtual machine, the second module may be replicated to a second replica virtual machine, and the third module may be replicated to a third replica virtual machine.

When a failover of the workload is initiated, the three applications may begin failover based on a particular order. For example, the first module may stop execution on the first primary virtual machine before the second module stops execution on the second virtual machine. Remaining data associated with the execution of the first module may be replicated (e.g., transferred) in a log to the first replica virtual machine before remaining data associated with the second module is replicated to the second replica virtual machine. In a similar manner, the second module may stop execution and/or replicate remaining data before the third module. By doing so, a module requiring more time to transfer remaining changes may begin a failover before another module requiring less time.

Additionally, or alternatively, the first, second, and third modules may begin execution on the first, second, and third replica virtual machines in a particular order. The order may specify that the first, second, and third modules begin execution in that order. In some instances, the first, second, and third modules begin execution after receiving input from, for example, a user and/or an application. The input may also specify the particular order. By doing so, a module requiring more start-up time may begin execution before another module requiring less start-up time. In some instances, this may allow a backend module to be fully functioning before a presentation module becomes fully functioning and avoid an error if the presentation module requires functionality of the backend module.

### Illustrative Migration Support

In some implementations, the validation techniques described herein may be implemented in the context of a migrating virtual machine. Here, a virtual machine may migrate within a plurality of computing devices configured in a cluster. That is, the virtual machine may migrate from being implemented on one computing device to being implemented on another computing device.

In one example, a replica virtual machine may migrate during a failover of a workload to the replica virtual machine. During the failover, a log may be sent to a computing device which is not implementing the replica virtual machine. In such instances, a broker of the replica virtual machine may be contacted to determine a computing device implementing the replica virtual machine.

To illustrate, a failover may be initiated causing a workload to stop execution on a primary virtual machine. In this illustration, a replica virtual machine may then migrate from being implemented on a first computing device to being implemented on a second computing device. Thereafter, the primary virtual machine may attempt to send remaining data in a log to the replica virtual machine, which is believed to be implemented on the first computing device. However, because the replica virtual machine has migrated, an error may occur indicating that the log was not sent to the replica virtual machine.

In such instances, a message may be sent from the primary virtual machine to a broker of the replica virtual machine requesting an identity of a computing device implementing the replica virtual machine. The broker may comprise a module and may be implemented on a computing device which is previously indicated to the primary virtual machine. The broker may have knowledge of the computing device implementing the replica virtual machine. In response to the message sent from the primary virtual machine, the broker may sent a message indicating that the replica virtual machine has migrated to be implemented on a particular computing device.

After receiving the message from the broker, the primary virtual machine may resend the log to the replica virtual machine based on the received message. That is, the primary virtual machine may resend the log to the particular computing device indicated in the received message.

In another example, a primary virtual machine may migrate during a failover of a workload from the primary virtual machine. Here, the primary virtual machine may continue the failover process automatically after the primary virtual machine has migrated.

### Illustrative User Interface

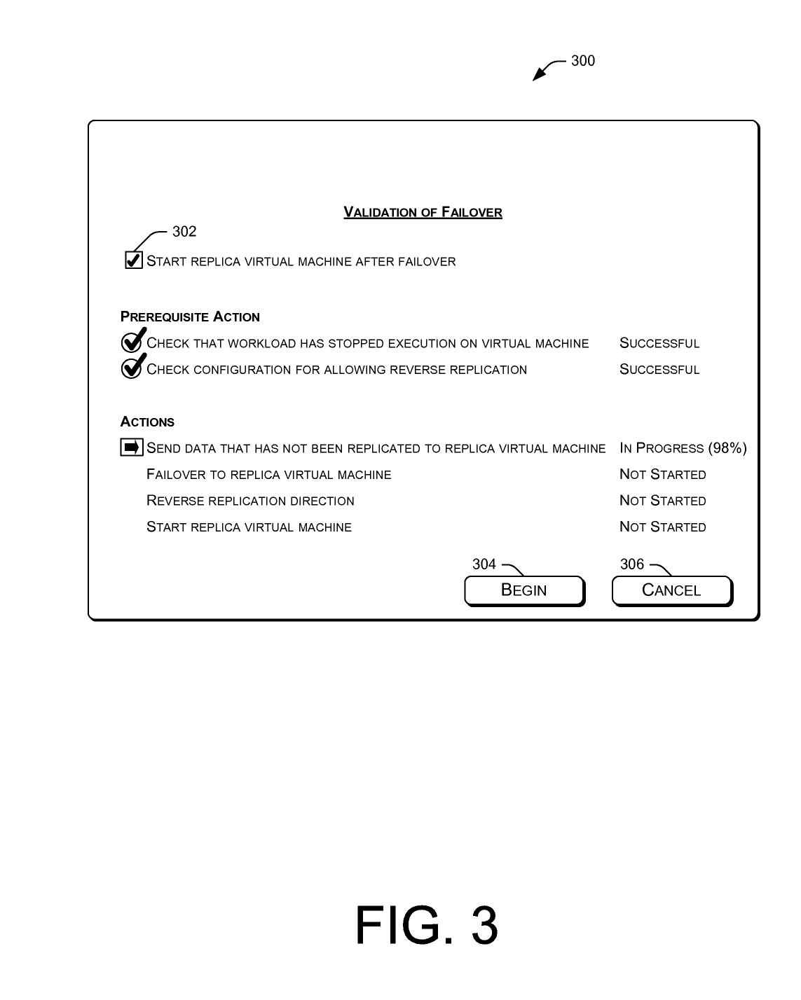

FIG. 3 illustrates an example user interface 300 that may be presented for validating a level of business continuity preparedness of a virtual machine. The user interface 300 may be presented to a user at any time before, during, or after a validation process. In some instances, the user interface 300 provides a one-click workflow for a user to start the validation process.

As illustrated, the user interface 300 includes a selection box 302 which may allow a user to specify whether to start a replica virtual machine after a failover to the replica virtual machine. In some instances, the user may wish to leave the selection box 302 uncheck and manually start the replica virtual machine. In some examples, this may be useful when a workload comprises a multi-tier application associated with a particular startup order and the user wishes to manually start modules of the multi-tier application.

The user interface 300 also includes a button 304 to begin the validation process and a button 306 to cancel the process. During execution of the validation process, the user may be presented with an indicator for an action indicating that the action is “not started,” “in progress,” or “successful” (meaning that the action was successfully completed).

Upon selection of the button 304, the validation process may automatically proceed to perform the prerequisite actions and the other actions without further user input. As illustrated, the validation process may include two prerequisite actions to:
check that a workload has stopped execution on a virtual machine (e.g., a primary virtual machine); and
check configuration(s) for allowing reverse replication—this check may include checking the configuration(s) of a host machine (e.g., a primary host machine) to verify that the host machine may receive replication logs after a workload begins execution on another virtual machine (e.g., a replica virtual machine).

When the prerequisite actions have been successfully completed, the validation process may proceed to:
send data that has not been replicated to a replica virtual machine;
failover to the replica virtual machine—this may include switching the workload to the replica virtual machine to begin execution;
reverse replication direction—this may include assigning the previous replica virtual machine to act as a primary virtual machine and assigning the previous primary virtual machine to act as a replica virtual machine; and
start the replica virtual machine—this may include executing the workload on the replica virtual machine.

### Illustrative Implementation

In some implementations, the validation techniques discussed herein may be implemented with a management interface, such as the Remote Windows Management Interface (Remote WMI). Here, a virtual machine may perform operations on the virtual machine and/or may instruct another virtual machine to perform operations through the Remote WMI.

For example, a primary virtual machine (e.g., the one or more primary virtual machines 102 of FIG. 1) may perform operations for executing a workload, stopping execution of the workload, checking configurations of a primary host machine, generating one or more logs associated with the workload, applying the one or more logs to memory of the primary virtual machine, and/or sending the one or more logs to a replica virtual machine. In addition, the primary virtual machine may instruct the replica virtual machine to, with the Remote WMI, perform operations for executing the workload, stopping execution of the workload, generating one or more logs associated with the workload, applying the one or more logs to memory of the replica virtual machine, and/or sending the one or more logs to the primary virtual machine.

By utilizing a remote interface, a user may validate business continuity preparedness from a computing device without having to input instructions on one computing device implementing a virtual machine and then having to input further instructions on another computing device implementing another virtual machine.

### Illustrative Processes

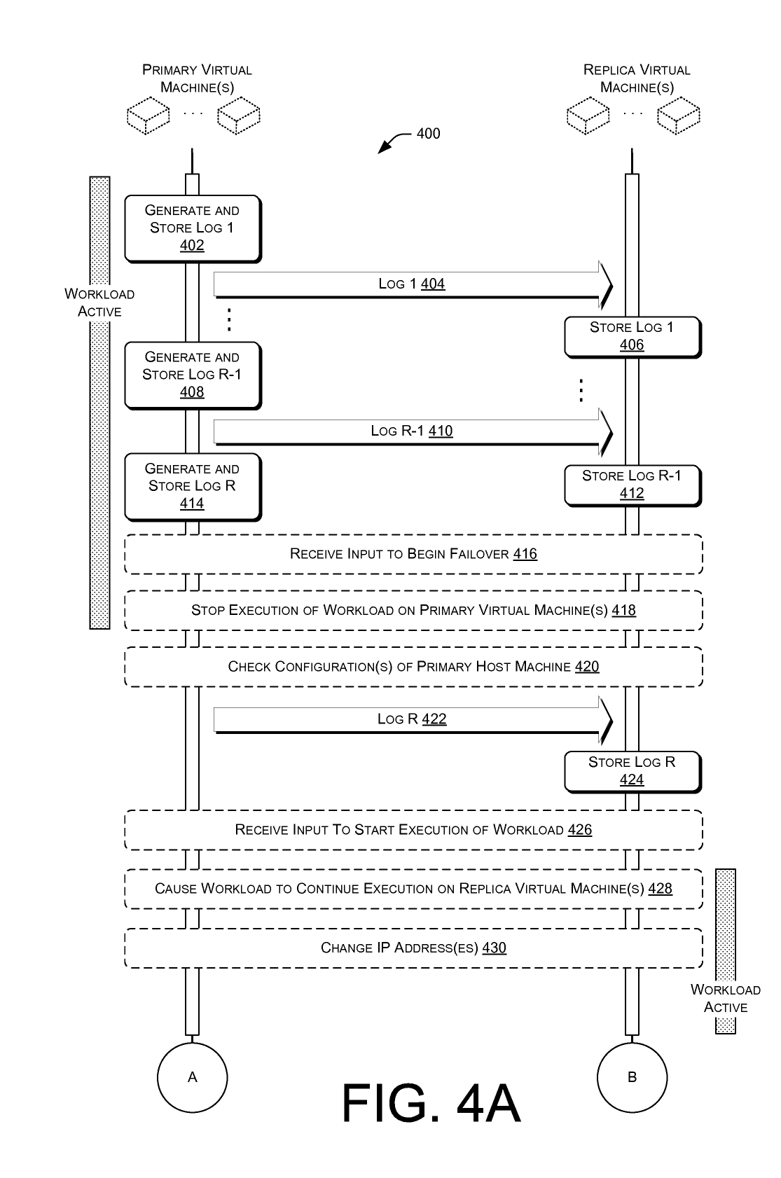

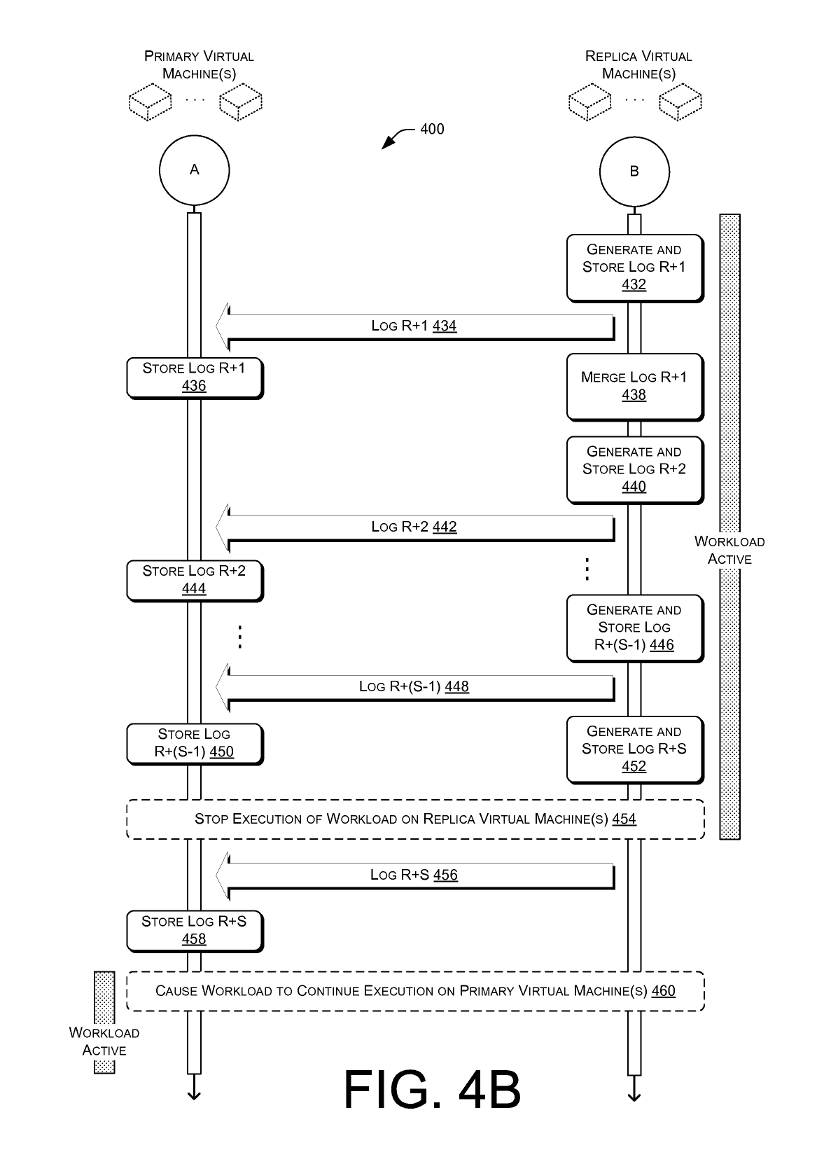

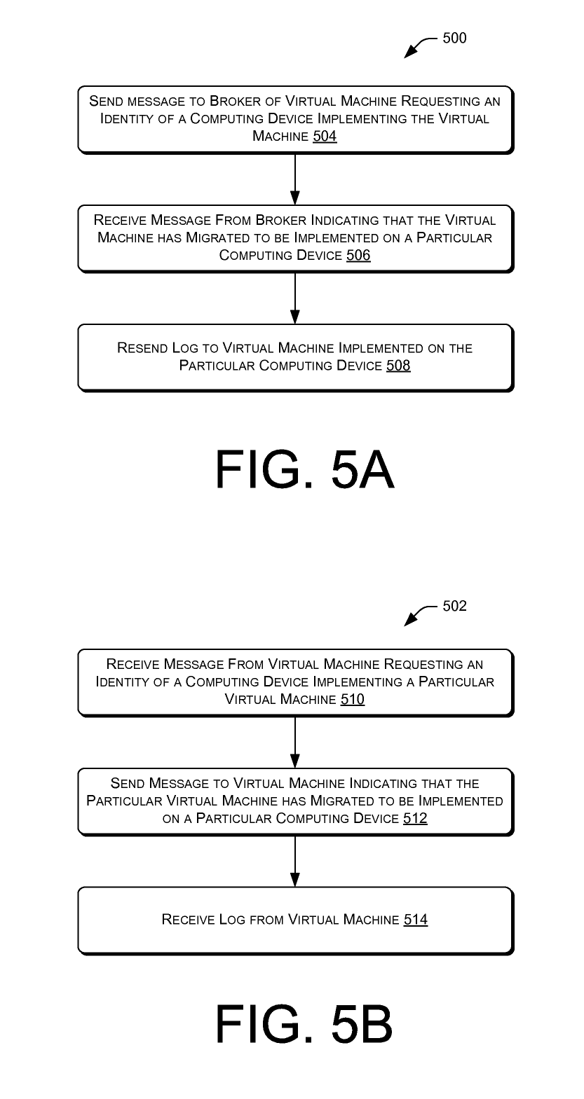

FIGS. 4A-4B and 5A-5B illustrate example processes 400, 500, and 502 for employing the techniques described herein. For ease of illustration processes 400, 500, and 502 are described as being performed in the architecture 100 of FIG. 1. For example, one or more of the individual operations of the processes 400, 500, and 502 may be performed by the computing device 110, the computing device 112, and/or the computing device 138. However, the processes 400, 500, and 502 are not limited to use with the example architecture 100 and may be implemented using other architectures and devices.

Although the following description of the processes 400, 500, and 502 may refer to operations performed by a primary virtual machine or a replica virtual machine, it should be understood that a primary virtual machine may function as a replica virtual machine and/or a replica virtual machine may function as a primary virtual machine as needed.

The processes 400, 500, and 502 (as well as each process described herein) are illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

In particular, FIGS. 4A-4B illustrate an example process 400 of replicating a workload from a primary virtual machine(s) to a replica virtual machine(s), failing over the workload from the primary virtual machine(s) to the replica virtual machine(s), and validating execution of the workload on the replica virtual machine(s).

The process 400 includes an operation 402 for generating a log 1 (i.e., a first log file) and storing the log 1 to memory of a primary virtual machine. For ease of illustration, the operation 402 is illustrated in one block. However, it should be understood that the generation of the log 1 and storage of the log 1 may be performed as separate operations. The operation 402 may include storing one or more changes caused by a workload executing on the primary virtual machine to the log 1 and storing the one or more changes to memory of the primary virtual machine. In some instances, the generation of the log 1 and the storage of the log 1 are performed simultaneously, while in other instances the generation and storage are performed at different times.

In the example architecture 100 of FIG. 1, the operation 402 may be performed by the one or more primary virtual machines 102. In particular, the operation 402 may be performed by the computing device 110 implementing the one or more primary virtual machines 102. For example, the replication module 122 of the computing device 110 may generate the log 1 and store the log 1 to the memory 116 of the computing device 110.

The process 400 also includes an operation 404 for transferring the log 1 to a replica virtual machine. The operation 404 may include an operation performed by the primary virtual machine for sending the log 1 from the primary virtual machine and an operation performed by the replica virtual machine for receiving the log 1. In the example architecture 100 of FIG. 1, the operation for sending the log 1 may be performed by the replication module 122 of the computing device 110, while the operation for receiving the log 1 may be performed by the replication module 134 of the computing device 112. In addition, the process 400 includes an operation 406 for storing the log 1 to memory of the replica virtual machine. In the example architecture 100 of FIG. 1, the operation 406 may be performed by the replication module 134.

The process 400 includes an operation 408 for generating a log (r−1) and storing the log (r−1) to memory of the primary virtual machine. The operation 408 may be similar to the operation 402 discussed above. In some instances, the operation 408 may begin while a previous log is transferred from the primary virtual machine and/or stored to the replica virtual machine. The process 400 also includes an operation 410 for transferring the log (r−1) to the replica virtual machine. The operation 410 may be similar to the operation 404 discussed above. The process 400 may also include an operation 412 for storing the log (r−1) to memory of the replica virtual machine. The operation 412 may be similar to the operation 406 discussed above.

The process 400 may also include an operation 414 for generating a log (r) and storing the log (r) to memory of the primary virtual machine. In some instances, the operation 414 may begin while a previous log is transferred from the primary virtual machine and/or stored to the replica virtual machine. The operation 414 may be similar to the operation 402.

Further, the process 400 may include an operation 416 for receiving input to begin a failover. The input may be received from, for example, a user and/or an application. The input may be received while the operation 414 is being performed. In some instances, the input specifies to automatically continue execution of the workload on the replica virtual machine without receiving further input and/or after remaining data is sent to the replica virtual machine. In other instances, the input specifies to continue execution of the workload on the replica virtual machine after receiving further input.

In the example architecture 100 of FIG. 1, the operation 416 may be performed by the validation module 146. As noted above, in some instances the validation module 146 is implemented in the computing device 138, while in other instances the validation module 146 is implemented in the computing device 110 or the computing device 112.

The process 400 may then proceed to an operation 418 for stopping execution of the workload on the primary virtual machine. In some instances, the operation 418 may include an operation for instructing the workload to stop execution on the primary virtual machine and an operation for checking that the workload stopped execution on the primary virtual machine. The process 400 may then proceed to an operation 420 for checking configuration(s) of a primary host machine. This may include checking that the primary host machine is configured to receive replication logs after the workload begins execution on the replica virtual machine. In the example architecture 100 of FIG. 1, the operations 418 and 420 may be performed by the validation module 146 implemented in the computing device 110, 112, or 138.

The process 400 may also include an operation 422 for transferring the log (r) to the replica virtual machine. The operation 422 may be similar to the operation 404 discussed above. In some instances, the log (r) includes any remaining changes that occurred on the primary virtual machine up to a time when the workload stopped execution on the primary virtual machine. The process 400 also includes an operation 424 for storing the log (r) to memory of the replica virtual machine. The operation 424 may be similar to the operation 406 discussed above.

In some instances, the process 400 includes an operation 426 for receiving input to start execution of the workload on the replica virtual machine. The input may be received from, for example, a user and/or an application. If, for example, the workload is a multi-tier application, the input may also indicate an order to start modules of the multi-tier application. In the example architecture 100 of FIG. 1, the operation 426 may be performed by the validation module 146 implemented in the computing device 110, 112, or 138.

In some instances, the process 400 may proceed to an operation 428 without performing the operation 426. While in other instances, the process 400 may proceed to the operation 428 after performing the operation 426. The operation 428 may cause the workload to continue execution on the replica virtual machine from a point where the workload stopped execution on the primary virtual machine. In some instances, modules of the workload may begin execution on the replica virtual machine in a particular order. In the example architecture 100 of FIG. 1, the operation 428 may be performed by the validation module 146 implemented in the computing device 110, 112, or 138.

The process 400 may also include an operation 430 for changing one or more IP addresses. The operation 430 may include changing an IP address associated with the virtual machine. In the example architecture 100 of FIG. 1, the operation 430 may be performed by the validation module 146 implemented in the computing device 110, 112, or 138.

The operation 400 may then proceed to an operation 432 for generating a log (r+1) and storing the log (r+1) to memory of the replica virtual machine. The operation 432 may include storing one or more changes caused by the workload executing on the replica virtual machine to the log (r+1) and storing the one or more changes to memory of the replica virtual machine. In some instances, the generation of the log (r+1) and the storage of the log (r+1) are performed simultaneously, while in other instances the generation and storage are performed at different times. In the example architecture 100 of FIG. 1, the operation 432 may be performed by the replication module 134 of the computing device 112.

The process 400 may also include an operation 434 for transferring the log (r+1) to the primary virtual machine. The operation 434 may include an operation performed by the replica virtual machine for sending the log (r+1) from the replica virtual machine and an operation performed by the primary virtual machine for receiving the log (r+1). In the example architecture 100 of FIG. 1, the operation for sending the log (r+1) may be performed by the replication module 134 of the computing device 112, while the operation for receiving the log (r+1) may be performed by the replication module 122 of the computing device 110. In addition, the process 400 includes an operation 436 for storing the log (r+1) to memory of the primary virtual machine. In the example architecture 100 of FIG. 1, the operation 436 may be performed by the replication module 122.

The process 400 may include an operation 438 for merging the log (r+1) to a particular memory of the replica virtual machine. For example, in some instances logs received before the workload began execution on the replica virtual machine (e.g., log 1 to log (r)) may have been stored to a first memory of the replica virtual machine. Here, a log generated after the execution of the workload began on the replica virtual machine (e.g., log (r+1)) may have been stored to a second memory of the replica virtual machine to preserve the first memory. In such instances, the operation 438 may be performed after a predetermined time period has expired in order to merge the log (r+1) stored in the second memory to the first memory. Thereafter, further logs generated at the replica virtual machine may be stored to the first memory.

The process 400 may include an operation 440 for generating a log (r+2) and storing the log (r+2) to memory of the replica virtual machine, an operation 442 for transferring the log (r+2) to the primary virtual machine, and an operation 444 for storing the log (r+2) to memory of the primary virtual machine. The operations 440, 442, and 444 may be similar to the operations 432, 434, and 436, respectively.

Further, the process 400 may include an operation 446 for generating a log (r+(s−1)) and storing the log (r+(s−1)) to memory of the replica virtual machine, an operation 448 for transferring the log (r+(s−1)) to the primary virtual machine, and an operation 450 for storing the log (r+(s−1)) to memory of the primary virtual machine. The operations 446, 448, and 450 may be similar to the operations 432, 434, and 436, respectively.

The process 400 may include an operation 452 for generating a log (r+s) and storing the log (r+s) to memory of the replica virtual machine. In some instances, the operation 452 may begin while a previous log is transferred from the replica virtual machine and/or stored to the primary virtual machine. The operation 452 may be similar to the operation 432.

The process 400 may also include an operation 454 for stopping execution of the workload on the replica virtual machine. In some instances, the operation 454 may include an operation for instructing the workload to stop execution on the replica virtual machine and an operation for checking that the workload stopped execution on the replica virtual machine. In the example architecture 100 of FIG. 1, the operation 454 may be performed by the validation module 146 implemented in the computing device 110, 112, or 138.

The process 400 may include an operation 456 for transferring the log (r+s) to the primary virtual machine. The operation 456 may be similar to the operation 434 discussed above. In some instances, the log (r+s) includes any remaining changes that occurred on the replica virtual machine up to a time when the workload stopped execution on the replica virtual machine. The process 400 also includes an operation 458 for storing the log (r+s) to memory of the primary virtual machine. The operation 458 may be similar to the operation 436 discussed above.

In addition, the process 400 may include an operation 460 for causing the workload to continue execution on the primary virtual machine. In some instances, modules of the workload may begin execution in a particular order. In the example architecture 100 of FIG. 1, the operation 460 may be performed by the validation module 146 implemented in the computing device 110, 112, or 138.

Meanwhile, FIGS. 5A-5B illustrate example processes 500 and 502 of transferring a log between virtual machines when one of the virtual machines has migrated to be implemented on a particular computing device. In some instances, the processes 500 and/or 502 may be performed during validation of a virtual machine. For example, the processes 500 and/or 502 may be performed in the context of the process 400 of FIGS. 4A-4B. In some instances, the processes 500 and 502 may be performed when a log is sent to a virtual machine (e.g., the operation 422 and/or 456) and an error occurs indicating that the log was not received at the virtual machine. This error may be caused by a virtual machine that migrates during failover and/or failback of a workload.

In FIG. 5A, the process 500 may be performed by a virtual machine (e.g., a primary and/or replica virtual machine) that is to send a log to another virtual machine. The process 500 may include an operation 504 for sending a message to a broker of a virtual machine requesting an identity of a computing device implementing the virtual machine. The message may be sent in response to an error indicating that a log was not received at the virtual machine. The broker may comprise a designated computing device from among a cluster of computing devices of the virtual machine.

The process 500 may also include an operation 506 for receiving a message from the broker indicating that the virtual machine has migrated to be implemented on a particular computing device. In response to receiving the message, an operation 508 may be performed for resending the log to the virtual machine implemented on the particular computing device. That is, the log is resent to the particular computing device indicated in the message received from the broker.

In FIG. 5B, the process 502 may be performed by a broker of a particular virtual machine (e.g., a primary and/or replica virtual machine). The process 502 may include an operation 510 for receiving a message from a virtual machine requesting an identity of a computing device implementing a particular virtual machine. In response, an operation 512 may be performed for sending a message to the virtual machine indicating that the particular virtual machine has migrated to be implemented on a particular computing device.

The process 502 may also include an operation 514 for receiving a log from the virtual machine. The log may be received at the particular computing device indicated in the message sent to the virtual machine.

### Conclusion

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
under control of one or more processors configured with executable instructions:
executing a workload on a first virtual machine;
generating a first log indicating changes occurring on the first virtual machine during execution of the workload;
causing the workload to stop execution on the first virtual machine;
sending the first log to a second virtual machine, the first log indicating
changes occurring on the first virtual machine to a point in time when execution of the workload was stopped on the first virtual machine;
causing the workload to continue execution on the second virtual machine after the first log is sent to the second virtual machine, the second virtual machine generating a second log during execution of the workload on the second virtual machine;
causing the workload to stop execution on the second virtual machine;
receiving the second log from the second virtual machine indicating changes occurring on the second virtual machine during execution of the workload on the second virtual machine;
applying the second log to the first virtual machine; and
causing the workload to continue execution on the first virtual machine.

2. The method of claim 1, wherein the first virtual machine is implemented on one or more computing devices located at a first location and the second virtual machine is implemented on one or more computing devices located at a second location that is different than the first location.

3. The method of claim 1, wherein the causing of the workload to continue execution on the second virtual machine occurs without user input.

4. The method of claim 1, further comprising:
changing, after the first log is sent to the second virtual machine, a virtual machine internet protocol (IP) address to an IP address associated with the second virtual machine.

5. One or more devices comprising:
one or more processors; and
memory storing executable instructions that, when executed by the one or more processors, cause the one or more processors to perform acts comprising:
causing a log to be generated at a first virtual machine indicating changes that have occurred during execution of a workload on the first virtual machine;
causing the workload to stop execution on the first virtual machine;
causing the log to be sent to a second virtual machine, the log indicating changes occurring on the first virtual machine to a point in time when execution of the workload was stopped on the first virtual machine;
causing the workload to continue execution on the second virtual machine; and
causing a further log to be sent from the second virtual machine to the first virtual machine indicating changes that have occurred during execution of the workload on the second virtual machine.

6. The one or more devices of claim 5, wherein the first virtual machine is implemented on one or more computing devices located at a first location and the second virtual machine is implemented on one or more computing devices located at a second location that is different than the first location.

7. The one or more devices of claim 5, wherein the further log is stored to memory of the first virtual machine after the further log is received at the first virtual machine.

8. The one or more devices of claim 5, wherein the acts further comprise:
changing, after the log is sent to the second virtual machine, a virtual machine internet protocol (IP) address to an IP address associated with the second virtual machine.

9. The one or more devices of claim 5, wherein the acts further comprise:
causing the log to be stored to first memory of the second virtual machine after the log is received at the second virtual machine; and
causing the further log to be stored to second memory of the second virtual machine, the second memory being different than the first memory.

10. The one or more devices of claim 5, wherein the acts further comprise:
causing the workload to stop execution on the second virtual machine after a predetermined time period has expired since the workload began execution on the second virtual machine; and
causing the workload to continue execution on the first virtual machine after causing the workload to stop execution on the second virtual machine.

11. The one or more devices of claim 5, wherein the acts further comprise:
determining, before causing the workload to continue execution on the second virtual machine, that a host machine of the first virtual machine is configured to receive one or more logs from the second virtual machine.

12. The one or more devices of claim 5, wherein:
the workload comprises a multi-tier application that is executed on a plurality of virtual machines that includes the first virtual machine, and
the causing the workload to continue execution on the second virtual machine includes causing a first application of the multi-tier application to be executed on one of a plurality of virtual machines that includes the second virtual machine before a second application of the multi-tier application begins execution on another virtual machine of the plurality of virtual machines that includes the second virtual machine.

13. The one or more devices of claim 12, wherein the acts further comprise:
receiving user input requesting that the first application of the multi-tier application be executed before the second application of the multi-tier application is executed.

14. The one or more devices of claim 5, wherein the acts further comprise:
sending a first message to a broker of the second virtual machine when an error occurs in sending the log to the second virtual machine, the first message requesting an identity of a computing device implementing the second virtual machine, the broker comprising a designated computing device from among a cluster of computing devices of the second virtual machine;
receiving a second message from the broker of the second virtual machine, the second message indicating that the second virtual machine has migrated to a particular computing device of the cluster of computing devices; and
causing the log to be resent to the second virtual machine implemented on the particular computing device based at least in part on the second message.

15. The one or more devices of claim 5, wherein the acts further comprise:
receiving user input specifying (i) to automatically continue execution of the workload on the second virtual machine after the log is sent to the second virtual machine, or (ii) to continue execution of the workload on the second virtual machine after receiving further user input,
wherein the workload continues execution on the second virtual machine based at least in part on the user input.

16. One or more computer-readable storage media storing computer-readable instructions that, when executed, instruct one or more processors to perform operations comprising:
receiving a first log from a first virtual machine indicating changes occurring on the first virtual machine during execution of a workload on the first virtual machine, the changes being to a point in time when execution stopped on the first virtual machine;
applying the first log to a second virtual machine;
executing the workload on the second virtual machine;
generating a second log indicating changes occurring on the second virtual machine during execution of the workload on the second virtual machine;
applying the second log to the second virtual machine; and
sending the second log to the first virtual machine after the second log has been generated.

17. The one or more computer-readable storage media of claim 16, wherein:
the applying the first log includes storing the first log to first memory of the second virtual machine; and
the applying the second log includes storing the second log to second memory of the second virtual machine, the second memory being different than the first memory.

18. The one or more computer-readable storage media of claim 17, wherein the operations further comprise:
merging the second log stored in the second memory to the first memory after a predetermined time period has expired since the second log was stored in the second memory.

19. The one or more computer-readable storage media of claim 16, wherein the operations further comprise:
sending a first message to a broker of the first virtual machine when an error occurs in sending the second log to the first virtual machine, the first message requesting an identity of a computing device implementing the first virtual machine, the broker comprising a designated computing device from among a cluster of computing devices of the first virtual machine;
receiving a second message from the broker of the first virtual machine, the second message indicating that the first virtual machine has migrated a particular computing device of the cluster of computing devices; and
causing the second log to be resent to the first virtual machine implemented on the particular computing device based at least in part on the second message.

20. The one or more computer-readable storage media of claim 16, wherein the operations further comprise:
generating, at least partly during the sending of the second log, a third log indicating changes occurring on the second virtual machine during execution of the workload on the second virtual machine.
